(19) United States
(12) Patent Application Publication
(10) Pub. No.: US 2013/0022731 A1
(43) Pub. Date: Jan. 24, 2013

(54) HIGH PROTEIN, LOW CARBOHYDRATE MEAL REPLACEMENTS AND FOOD

(71) Applicant: Sean Olson, Santa Monica, CA (US)

(72) Inventor: Sean Olson, Santa Monica, CA (US)

(73) Assignee: VIA SANA LLC, Los Angeles, CA (US)

(21) Appl. No.: 13/555,103

(22) Filed: Jul. 21, 2012

Related U.S. Application Data
(60) Provisional application No. 61/511,018, filed on Jul. 22, 2011.
(60) Provisional application No. 61/514,047, filed on Aug. 2, 2011.

(51) Int. Cl. A23L 1/32; A23L 1/01

(52) U.S. Cl. 426/614; 426/438

(57) ABSTRACT

Protein-based meal replacements and foods, methods of manufacturing the protein-based meal replacements and foods, and different forms of the protein-based meal replacements and foods are disclosed. Implementations of the invention include combinations of egg based materials and value-added ingredients processed to form desired end products. Examples of end products include, but are not limited to, snack chips, crisps, croutons, French fries, cookies, donuts, breads, taco shells, tortillas, cereal, coatings, and other types of fried, baked, puffed, and/or otherwise cooked products.

This application claims priority to U.S. Provisional Application No. 61/511,018, filed Jul. 22, 2011 and entitled “MEAL REPLACEMENT PRODUCTS,” and U.S. Provisional Application No. 61/514,047, filed Aug. 2, 2011 and entitled “HIGH PROTEIN, LOW CARBOHYDRATE MEAL REPLACEMENTS AND FOODS,” both of which are hereby incorporated herein by reference.

### FIELD OF THE INVENTION

The present invention relates to protein-based meal replacements and foods, methods of manufacturing the protein-based meal replacements and foods, and different forms of the protein-based meal replacements and foods.

### BACKGROUND OF THE INVENTION

People are becoming increasingly conscious about what they eat. Scientific and medical data has demonstrated that one of the most effective methods to control body weight and shape is to regulate the relative amounts of protein and carbohydrates. A diet high in protein and low in carbohydrates can result in lower levels of lipids in the body, less frequent blood glucose spikes, and increasing muscle mass. The combination of macronutrients noted above satisfies hunger while still creating a chemical response of satiety for the consumer.

Notwithstanding this increasing awareness, obtaining food items that are convenient, tasty, high in protein and low in carbohydrates can be challenging. The fast pace of cosmopolitan life dictates that people rely on fast food and pre-packed snack products. Many popular snack foods are largely comprised of carbohydrates and are therefore not conducive to controlling body fat. For instance, while potato chip brands such as Pop Chips, Kettle, and baked chips from various manufacturers are marketed as healthy due to lower levels of fat, they typically have a higher percentage of carbohydrates than their non-low fat counterparts.

Some consumers rely on meal replacement products such as protein bars and protein shakes, but they are often expensive and tasteless and also can contain high levels of carbohydrates.

While there are some protein based snack products on the market, they generally use soy protein, typically have low overall protein content, and have substantial amounts of carbohydrates. Most of today's snack products marketed as high protein contain soy protein only. Further, the soy protein in these snacks is typically simply added to an existing recipe rather than used as substitute for carbohydrates as in the present invention. Soy protein has lower bioavailability than other forms of protein such as egg protein. Further, some research suggests that soy protein may cause problems such as hormonal imbalance, low thyroid output, and allergies.

Eggs are an excellent source of protein. Indeed, due to their protein content, the United States Department of Agriculture categorizes eggs as Meats within the Food Guide Pyramid. Egg whites, in particular, have become very popular as a core component of a high protein, low carbohydrate diet. Egg protein contains vital amino acids such as alanine, arginine, and glycine. Egg protein also contains Vitamin D, enhances digestion, and is absorbed in less time than whey protein.

Despite the clear health benefits of egg whites, there are currently no available, prepackaged snack products based on egg protein. Yashoda, et. al disclose whole egg chips prepared by using flour products as binders. The loading of the flour is substantially equivalent to the egg, resulting in products with substantial amounts of carbohydrates. Further, the recipe and cooking method provided is not compatible with substantially higher carbohydrate-to-protein ratios. If the carbohydrate loading of the aforementioned product is reduced, a satisfactory product cannot be fabricated with the method described in the paper.

U.S. Pat. No. 7,939,123 discloses a method for making an egg based product that has a crispy exterior and is soft on the inside, having the “ . . . texture of a deep-fried French fry potato”. In the patent, the solid mass is deep fried for a short period of time, so that the exterior of the product is crispy, but the interior remains moist like a French fried potato. The patent does not discuss or mention the term “chip”. The resulting high moisture content interior makes it unsuitable for storage in the form of a ready-to-eat, packaged snack. Further, the moist middle has a consistency that results in poor mouth feel and is unlike a chip. Hence, there is a need for new egg-based meal replacement products and foods and methods for making such products.

### SUMMARY OF THE INVENTION

The present invention relates to protein-based meal replacements and foods, methods of manufacturing the protein-based meal replacements and foods, and different forms of the protein-based meal replacements and foods. In one specific implementation, the present invention relates to a new class of food that is crispy, tasty, and low in carbohydrates and has substantial levels of egg white protein and suitable shelf life for packaging in ready to eat form.

The present invention also relates more generally to food products created by substituting proteins for carbohydrates and methods for their manufacture.

In one specific implementation of the present invention, a combination of egg based materials and value-added ingredients are combined and processed to form a desired end product. Egg based materials are any materials comprising whole egg, egg yolk, egg white, egg protein, egg white protein, egg yolk extract, egg white extract, egg yolk powder and/or egg white powder, including (but not limited to) liquid egg whites and/or egg white powder. Value added ingredients are any materials combined with the egg based materials to enhance the end product such as water, hydrocolloids, starches, flours, oil, flavorings, materials that provide structure (such as vegetable matter, seaweed, or fiber) and/or antioxidants. The end product is any product that incorporates the egg based materials and is made according to the present invention. Examples of end products include, but are not limited to, snack chips, crisps, croutons, French fries, cookies, donuts, breads, taco shells, tortillas, cereal, coatings, and other types of fried, baked, puffed, and/or otherwise cooked products.

In another implementation of the present invention, variants of existing food products are created by substituting proteins for carbohydrates in the existing food product. For example, one specific implementation of the present invention is a bread product wherein a portion of the flour has been replaced with a formulation comprising egg whites and the processing has been modified to accommodate such a change. The resulting product may be branded with a symbol that conveys to consumers that such a process has been performed, similar to the Splenda™ brand that appears on various products today and communicates to consumers that either all or a portion of the traditional carbohydrate-laden sweeteners in the have been replaced with lower calorie, lower carbohydrate Splenda™. Other similar specific implementations include pasta, muffins, breakfast cereals, bread sticks, pastries, and baked goods.

Further aspects of the invention will be brought out in the following portions of the specification, wherein the detailed description is for the purpose of fully disclosing preferred embodiments of the invention without placing limitations thereon.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed.

### BRIEF DESCRIPTION OF THE DRAWINGS

The invention can be better understood by reading the following detailed description with reference to the accompanying Figures in which:

FIGS. 1-5 are images of high protein, low carbohydrate meal replacements and foods according to certain embodiments of the present invention.

### DETAILED DESCRIPTION OF THE DRAWINGS

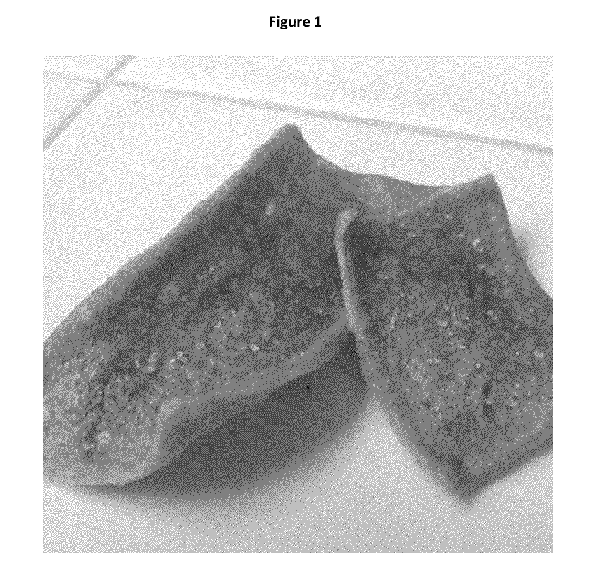

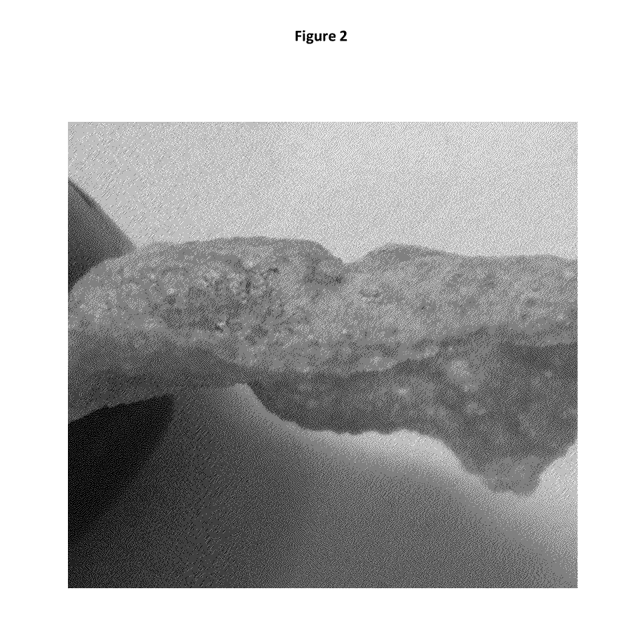

The invention is related to a protein-based product that has a crispy texture and is low in carbohydrates. One embodiment of the invention is an egg-based product that has a crispy texture, is low in carbohydrates, and has a uniform texture. FIG. 1 shows the outside of an egg-based product according to certain embodiments of the present invention, and FIG. 2 shows the inside of that product. The product does not have a soft and chewy middle section. Rather, the inside is a solid, fully cooked, and porous network of proteins and other ingredients with a crispy texture (in stark contrast to the interior of the product disclosed in U.S. Pat. No. 7,939,123). Note that the invention disclosed in U.S. Pat. No. 7,939,123 has a crispy exterior, but the interior resembles the interior of a French fry. The end product of one implementation of the present invention is made to enable a uniform texture throughout the final product.

Another embodiment of the invention is an egg-based product that has a crispy texture, is low in carbohydrates, and has a shelf life of at least four months. In certain embodiments the shelf life is longer than six months.

In certain embodiments of the present invention, the water is substantially removed from the end product resulting in both a crisp exterior and interior. In certain embodiments, the moisture of the end products is between 0.25% and 15%. In Example 8, the moisture percentage of the end products is 8% prior to any drying. The relatively low moisture content results in longer shelf life. It is believed that the water activity of the end products is between 0.1 and 0.5, which is sufficient to suspend the growth of yeast, mold and bacteria. Additionally, other ingredients such as anti-oxidants and preservatives can be used to further extend the shelf life of the present invention. Additionally, the oil content and corresponding susceptibility to oil rancidity can be reduced by reducing the oil content of the final product, as through the blowing of hot air on the end product after frying or modifying the ratios of the hydrocolloids, starch, and flour.

Another embodiment of the present invention is an egg-based product that has a crispy texture, is low in carbohydrates and has at least 12 grams of egg white protein in a one ounce serving. Currently-sold, protein-based snack products have only nine grams of soy protein in a one ounce serving. In certain embodiments, the end products can contain protein isolate from soy, rice, whey, or other sources, in addition to the protein from the egg based materials.

Another embodiment of the present invention is a product that has a crispy texture throughout, is low in carbohydrates and has at least 12 grams of protein that is readily bioavailable in a one ounce serving.

Another embodiment of the invention is a method for making an egg-based product and the product produced thereby that has a crispy texture and is low in carbohydrates comprising the following steps: formation of a liquid formulation, deposition of the liquid formulation on a defined area to have a specific wet thickness, heating of the formulation to a desired temperature for a desired length of time to form a flexible film, processing of pieces of the flexible film in oil to form a crispy texture, and drying the product to reduce oil and better the textural properties.

Another embodiment of the invention is a method for making an egg-based product and the product produced thereby that has a crispy texture and is low in carbohydrates comprising the following steps: formation of a liquid formulation, deposition of the liquid formulation on a heated and defined area to have a specific wet thickness, heating of the formulation to a desired temperature for a desired length of time to form a flexible film, baking the product to form a crispy texture, and drying the product to reduce oil and better the textural properties. The drying step may comprise any combination of air drying, exposing to hot blasts of air, and/or baking.

Another embodiment of the invention is a method for making an egg-based product and the product produced thereby that has a crispy texture and is low in carbohydrates comprising the following steps: formation of a liquid formulation, heating of the liquid formulation to achieve gelling of egg protein, cutting of the gelled formulation into shapes suitable for eating, baking the product to form a uniformly crispy texture, and drying the product to reduce oil and better the textural properties. The drying step may comprise any combination of air drying, exposing to hot blasts of air, and/or baking.

Another embodiment of the invention is a method for making an egg-based product and the product produced thereby that has a crispy texture and is low in carbohydrates comprising the following steps: formation of a liquid formulation, heating of the liquid formulation to achieve gelling of egg protein, cutting of the gelled formulation into shapes suitable for eating, frying the product to partially cook it, baking the product to form a uniformly crispy texture, and drying the product to reduce oil and better the textural properties. The drying step may comprise any combination of air drying, exposing to hot blasts of air, and/or baking.

The aforementioned methods of making the egg-based products will be described in more detail below.

Another embodiment of the present invention is a liquid formulation used to make an egg-based product that has a crispy texture and is low in carbohydrates. The liquid formulation is comprised of ingredients including, but which are not limited to, egg whites, water, a hydrocolloid, starch, and/or flour. Different hydrocolloid systems can be used to control the texture and viscosity of the end product. Examples of hydrocolloids that might be used include, but are not limited to, agar, alginate, gum Arabic, carrageenan, cellulose, galactomannans, inulin, konjac, modified gum Arabic, pectin, and/or xanthan gum. Different starches can be used to control the water retention, porosity, puffiness, crispiness, and/or mouth feel of the end products. For example, different starches that might be used include, but are not limited to, tapioca starch, corn starch, waxy maize starch, high-amylose corn starch, potato starch, sweet potato starch, and wheat starch. Flours can be used to engineer the structure, thickness, and/or texture of the end product. Without limiting any of the foregoing, specific flours that might be used are rice flour, sweet rice flour, glutinous rice flour, barley flour, millet flour, amaranth flour and/or legume flours. Anti-oxidants can extend the shelf life by reducing the rate of oxidations of the oils. Examples of anti-oxidants include, but are not limited to, Vitamin E and/or Rosemary oil extract. Other preservatives can use used to extend shelf life by, for example, preventing the growth of yeasts, molds, and/or bacteria on foods. Examples of preservatives that might be used include (but are not limited to) sulfur dioxide, sulfites, propionic acid, benzoate, antimicrobials, potassium salts, phosphates, nitrates, and/or nitrites.

In a certain preferred embodiment of the present invention, a formulation is made comprising egg white materials, water, xanthan gum, starch, rice flour, and/or oil. The egg white materials are greater than 60% by weight of the formulation, although the exact amount may be varied to determine the exact protein content of the end product. A preferred embodiment is shown in Example 8. The egg white materials are 64% of the formulation. The formulation may comprise between 10% to 25% of water. Preferably, the water concentration is about 15%. The hydrocolloid system with the desired functional benefits is 0.02% to 0.5% of the formulation. Preferably, xanthan gum is used at a 0.2% concentration. The amount of starch can vary from 0.5% to 20% of the formulation, depending on the functional properties in the end product. In a preferred embodiment, the tapioca starch is 0.8% of the formulation. Flour concentration may range from 1% to 20%. Preferably, rice flour is 14% of the formulation. Finally, if oil is used at all, it may be included in ranges from 0% to 9%. Preferably, 6% soybean oil is used in the formulation.

One side effect of high protein consumption and, for some individuals, high egg and/or egg white consumption is gas and flatulence arising from difficulty in digesting the egg protein. Consequently, in some embodiments of this invention, additional ingredients are added to the product at various stages of its manufacture to aid in the digestion of egg proteins. These ingredients comprise: digestive enzyme supplements; proteases such as pepsin and trypsin; sugars which aherbal bitters such as Swedish Bitters and L-carnitine; certain spices such as cumin, coriander, caraway, turmeric, and kombu kelp; bromelain; and papain. In some embodiments, the manufacturing process is modified to more fully cook the protein in order to improve its digestibility.

A method according to certain embodiments comprises heating the egg white powder prior to use of the egg white powder in the liquid formulation. Such a heating step can improve the gelling ability of the egg white protein, which can lead to greater water retention in the initial cooking step and a superior end product.

In another embodiment of the present invention, the liquid formulation comprises sugar and/or other complex carbohydrates to improve the stability of the egg white materials. Egg white powders generally have less sugar. Thus, when egg white powders are used as the egg white materials in the formulation, the addition of sugar can lead to reduced grittiness in the final product.

In certain embodiments of the present invention, the pH of the formulation is changed to improve the gelling ability of the egg materials which can lead to greater water retention in the initial cooking step and a superior end product.

A method according to certain embodiments of the present invention comprises mixing the formulation to uniformly disperse the value-added ingredients. For example, the formulation may be mixed with a whisk for approximately two minutes. In a high volume production setting, an industrial Hobart Mixer might be used to perform the mixing. In another embodiment of the invention, the formulation is mixed so that minimal foam is formed. Various techniques and tools can be used to mix the formulation without foam. For example, anti-foaming agents can also be used to minimize formation of the foam in the formulation.

In a further embodiment of the present invention, the formulation is deposited on a defined area of a flat surface at a determined thickness. The surface may either contain indented templates or it may be a flat sheet. The indented templates may conform to the size and shape of the desired end product. The wet thickness of the deposited formulation should be between 2 millimeters and 6 millimeters. In a preferred embodiment, the wet thickness may be about 3.18 millimeters. The surface may be heated or placed in a heated environment.

A method according to another embodiment of the present invention comprises manufacturing an egg-based product using an extrusion process. The method involves subjecting a formulation comprising egg white protein to a pressure differential and heat (dry or steam) sufficient to cause the formulation to cook. When the product exits the extruder, it may either be further processed or be ready to eat. In some implementations, the pressure differential experienced by the food product may cause an increase in size of the food product. Additional processing may or may not be performed on the food product.

In another embodiment of the invention, a formulation to create an egg-based product is heated in an extruder. When it exits the extruder and in a solid or semi-solid form it is sliced into the desired shape and fried. It may then be baked or processed in any number of ways to remove excess oil.

In another embodiment of the invention, a formulation to create an egg-based product is heated in an extruder. When it exits the extruder and in a solid or semi-solid form it is sliced into the desired shape. It may then be baked or processed in any number of ways to remove excess oil.

In another embodiment of the present invention, the formulation is heated to a desired temperature for a desired length of time to form a flexible film. The appropriate temperature and length of time can be varied, depending on the apparatus and cooking technique used and desired properties of the end product. Examples of equipment and techniques that might be used include an oven, a heated surface such as a temperature controlled griddle, and/or a heated extruder. In one embodiment, the formulation should be heated sufficiently to result in formation of a flexible film, but not be heated so long that it results in complete evaporation of the water or a Maillard reaction. In one embodiment, the formulation is heated on a surface between 130 F and 240 F until the desired films are formed. Preferably, the formulation is heated on a surface between 180 F and 210 F for about ten to forty seconds. In a specific embodiment, the formulation is heated on a surface at 200 F for 1 minute and 30 seconds. The corresponding moisture percentage of the flexible film is between 70% and 90%. The moisture percentage of the flexible film in Example 8 is 80.9%. It is believed that the water activity of the flexible film is between 0.6 and 0.8. The flexible film may then be fried or baked or a combination thereof to create the food product.

A method according to another embodiment of the present invention comprises processing the flexible film to form articles of a desired size and shape. If the formulation was deposited on a flat sheet, the flexible film is cut to form articles according to the size and shape of the desired end product. For example, a dough cutter might be used to cut the flexible film. The articles of the desired size and shape are then cooked in oil for a length of time and at a temperature to obtain the desired end product.

In a preferred embodiment, the flexible films are cooked in oil using a frying process. Examples of oil that can be used include, but are not limited to, soybean oil, grape seed oil, sunflower oil, safflower oil, and rice bran oil. The frying takes place for a period of time sufficient to result in a crisp outer layer around the articles. Generally, the frying takes place at a temperature greater than 250 F between thirty seconds and twelve minutes. Preferably, the frying takes place for one minute at 340 F.

In another embodiment of the present invention, the articles are subject to a subsequent drying step. For example, the articles are placed in a heated environment such as an oven for a period of time sufficient to solidify the remaining coagulated protein structure. Preferably, the articles are heated in a convection oven at 400 F for ten minutes. The moisture percentage of the articles is between 0.25% and 20%. The moisture percentage of the articles in Example 8 is 10%. It is believed that the water activity of the articles is between 0.2 and 0.5.

In another embodiment of the present invention, the formulation may be engineered and processed so that it can be directly fried, without the need for other cooking steps. For example, a formulation is prepared according to Example 6. The formulation is stirred until a foamy substance is formed. For example, a Hobart mixer can be used to stir the formulation for five to twenty minutes. The foamy substance can then be deposited into frying oil according to the desired shape and size of the desired end product. The end product is highly porous and crunchy.

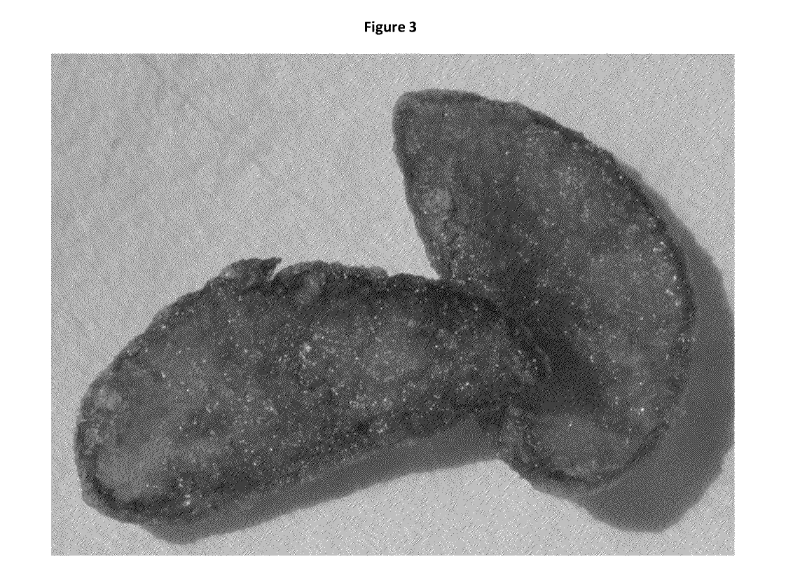

Another embodiment of the invention is an egg-based product that is crispy and low in carbohydrates and has a circular or semi-circular shape, at least one curved edge, a thickness of between 0.5 millimeters and 3 millimeters, and a diameter between 2 millimeters and 6 centimeters. FIG. 3 provides an example.

A further embodiment of the invention is an egg-based product that is crispy and low in carbohydrates and has a rectangular shape with a thickness of at least 0.5 millimeters, a length of at least 0.5 centimeters, and a width of at least 0.25 centimeters. An example is shown in FIG. 1.

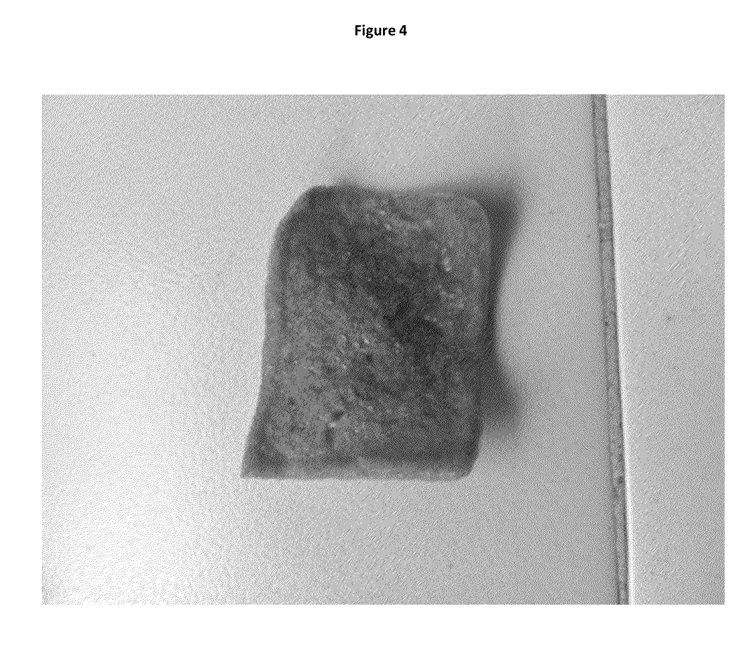

Another embodiment of the invention is egg-based product that is crispy and has a square shape with a thickness of at least 0.5 millimeters and a length of at least 0.25 centimeters. An example is shown in FIG. 4.

Another embodiment of the invention is an egg-based product that is crispy and is used as a topping on a salad.

Another embodiment of the invention is an egg-based product that is crispy and is used as replacement for grain-based cereals.

Another embodiment of the invention is an egg-based product that is crispy and is used as replacement for crackers.

Another embodiment of the invention is an egg-based product that is dried for storage and then boiled and is used as replacement for grain-based pastas.

Another embodiment of the invention is an egg-based product that is crispy and is used as replacement for ice cream cones.

Another embodiment of the invention is an egg-based product that is based and is used as replacement for grain-based breads.

Another embodiment of the invention is an egg-based product that is crispy and is used as a replacement for a grain-based cookie.

Another embodiment of the invention is an egg-based product that is crispy and is used as a replacement for a tortilla.

Another embodiment of the invention is a formulation comprising egg materials and hydrocolloids that can be used to replace starch in an existing food product. Another embodiment of the present invention is a formulation comprising egg white material and a plant-based matrix such as sea weed that is fried.

Another embodiment of the invention is a formulation comprising whey protein, starch, hydrocolloids, and flour that is used to prepare high-protein crispy snacks.

### Example 1

A formulation comprising solely liquid egg whites was deposited at 5 millimeters thickness on a flat tray. The liquid egg whites were baked in a convection oven for 40 minutes at 200 F until the egg whites became semi-coagulated. The egg whites were then fried for 10 minutes at 300 F. The resulting product was similar to a cooked egg. No crispy texture was observed.

### Example 2

80 grams of liquid egg whites and 20 grams of water were mixed together. A 5 millimeter thick film of the formulation was deposited on a flat tray. The formulation was baked for 40 minutes at 200 F in a convection oven until the formulation became semicoagulated. The water did not stay in solution with the egg whites, and the formulation could not be properly fried.

### Example 3

A formulation was prepared based on the following ingredients:

| Additive | Amount By Weight (Grams) |
|---|---|
| Liquid Egg Whites | 154.05 |
| Water | 40 |
| Xanthan Gum | .132 |
| Tapioca Starch | 1.32 |
| Sweet Rice Flour | 2.64 |
| Vegetable Oil | 9.2 |

A 5 millimeter thick film was deposited on a flat tray, and the formulation was baked for one hour and five minutes at 220 F in a convection oven until the formulation became semicoagulated. Strips of the flexible film were then fried in soybean oil for 7 minutes at 300 F. The resulting product did not have a uniform and porous texture. Rather, the center contained moist egg white.

### Example 4

A formulation was prepared based on the following ingredients:

| Additive | Amount By Weight (Grams) |
|---|---|
| Liquid Egg Whites | 150.21 |
| Water | 39.93 |
| Xanthan Gum | .13 |
| Tapioca Starch | 1.31 |
| Sweet Rice Flour | 6.21 |
| Vegetable Oil | 9.19 |

A 5 millimeter thick film was deposited on a flat tray, and the formulation was baked for 42 minutes at 205 F in a convection oven until the formulation became semi-coagulated. Strips of the flexible film were then fried in soybean oil for 7 minutes at 300 F. The resulting product did not have a uniform and porous texture. Rather, the center contained moist egg white.

### Example 5

A formulation was prepared based on the following ingredients:

| Additive | Amount By Weight (Grams) |
|---|---|
| Liquid Egg Whites | 159.4 |
| Water | 39.3 |
| Xanthan Gum | .12 |
| Tapioca Starch | 1.32 |
| Sweet Rice Flour | 6.21 |

The formulation was deposited on the flat surface of a specific area with a wet thickness of 1 millimeter. The formulation was baked in a convection oven for 40 minutes at 205° F. and allowed to cool until it reached 104° F. The flexible film was too thin and could not be removed from the flat surface.

### Example 6

A formulation was prepared based on the following ingredients:

| Additive | Amount By Weight (Grams) |
|---|---|
| Liquid Egg Whites | 159.4 |
| Water | 39.3 |
| Xanthan Gum | .12 |
| Tapioca Starch | 1.32 |
| Sweet Rice Flour | 6.21 |

The formulation was whisked in a Hobart Mixer for seven minutes until a foamy network was formed. The foamy network was split into two batches. The first batch was deposited as a 10 millimeter film to and pre-dried in an oven at 205° F. oven, resulting in a flat layer that could not be removed from the surface. The second batch was deposited in 5 gram increments directly into oil at 320° F. The resulting product was highly porous and crunchy.

### Example 7

A formulation was prepared based on the following ingredients:

| Additive | Amount By Weight (Grams) |
|---|---|
| Liquid Egg Whites | 76 |
| Water | 19 |
| Xanthan Gum | .5 |
| Tapioca Starch | 1 |
| Wheat Flour | 6 |
| Soybean Oil | 5 |

The formulation was then deposited on a griddle top that was heated to 180° F. for one minute until the formulation was fully opaque. The flexible film was removed from the heated surface to stop further coagulation. The flexible film was sliced into strips and placed in oil at 340° F. for 7 minutes. The resulting products were oily and contained a strong egg taste.

### Example 8

A formulation was prepared based on the following ingredients:

| Additive | Amount By Weight (Grams) |
|---|---|
| Liquid Egg Whites | 76 |
| Water | 18 |
| Xanthan Gum | .2 |
| Tapioca Starch | 1 |
| Rice Flour | 16.6 |
| Soybean Oil | 7 |

The formulation was then deposited on a griddle top that was heated to 180° F. for one minute until the formulation was fully opaque. The flexible film was removed from the heated surface to stop further coagulation. The flexible film was sliced into strips and divided into two batches. One batch was placed in oil at 340° F. for 30 seconds. A second batch was placed in oil at 340° F. for one minute. Both batches were baked at the same time at 400° F. for 10 minutes. The resulting products were crisp and crunchy, did not contain a strong egg taste, and were not excessively oily.

### Example 9

A formulation was prepared based on the following ingredients:

| Additive | Amount By Weight (Grams) |
|---|---|
| Liquid Egg Whites | 76 |
| Water | 18 |
| Xanthan Gum | .2 |
| Tapioca Starch | 1 |
| Rice Flour | 16.6 |
| Soybean Oil | 7 |

The formulation was then deposited on a griddle top that was heated to 200° F. for one minute until the formulation was fully opaque. The flexible film was removed from the heated surface to stop further coagulation. The flexible film was sliced into strips and divided into two batches. One batch was placed in oil at 340° F. for 30 seconds. A second batch was placed in oil at 340° F. for one minute. Both batches were baked at the same time at 400° F. for 10 minutes. The resulting products were crisp and crunchy, did not contain a strong egg taste, and were not excessively oily.

### Example 10

A formulation was prepared based on the following ingredients:

| Additive | Amount By Weight (Grams) |
|---|---|
| Powdered Egg Whites | 15 |
| Water for hydration | 63 |
| Water | 18 |
| Xanthan Gum | .2 |
| Tapioca Starch | 1 |
| Rice Flour | 16.8 |
| Soybean Oil | 7.2 |

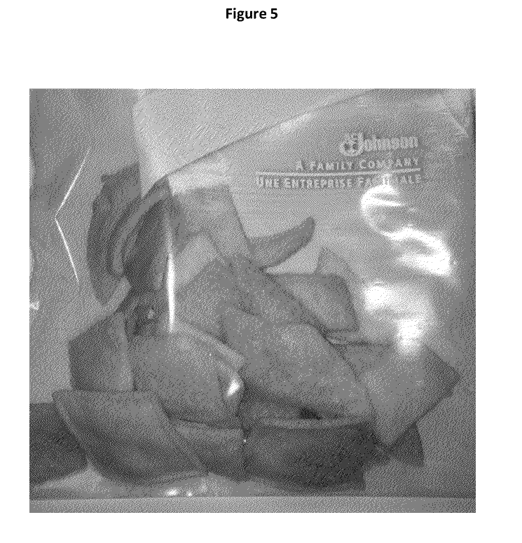

The formulation was prepared by hydrating the powdered egg whites for 30 minutes and then combining with the remaining ingredients. The formulation was then deposited on a griddle top that was heated to 200° F. for one minute until the formulation was fully opaque. Thickness was approximately 0.20 inches. The flexible film was removed from the heated surface to stop further coagulation. The flexible film was sliced into strips with approximate dimensions of 1.3 inches by 0.6 inches. The product was then baked in a convection oven at 300° F. for 35 minutes. Another batch using the same formulation was baked at 400° F. for 21 minutes. The resulting products from both batches were crisp and crunchy, uniformly cooked, did not contain a strong egg taste, and were not excessively oily. This example demonstrates that the products can be prepared without a frying step. A 1 ounce bag of the products is shown in FIG. 5.

### Example 11

A formulation was prepared based on the following ingredients:

| Additive | Amount By Weight (Grams) |
|---|---|
| Powdered Egg Whites | 15 |
| Water for hydration | 63 |
| Water | 18 |
| Xanthan Gum | .2 |
| Tapioca Starch | 0 |
| Rice Flour | 16.8 |
| Soybean Oil | 7.2 |

The formulation was prepared by hydrating the powdered egg whites for 30 minutes and then combining with the remaining ingredients. The formulation was then deposited on a griddle top that was heated to 200° F. for one minute until the formulation was fully opaque. Thickness was approximately 0.20 inches. The flexible film was removed from the heated surface to stop further coagulation. The flexible film was sliced into strips with approximate dimensions of 1.3 inches by 0.6 inches. The product was then fried in baked in 300° F. rice bran oil for 45 seconds. It was then baked in a convection oven at 300° F. for 35 minutes. In another variation of this recipe, the baking was done at 400° F. for 21 minutes. The resulting products were crisp and crunchy, did not contain a strong egg taste, and were not excessively oily.

### Example 12

A formulation was prepared based on the following ingredients:

| Additive | Amount By Weight (Grams) |
|---|---|
| Powdered Egg Whites | 15 |
| Water for hydration | 63 |
| Water | 18 |
| Xanthan Gum | .2 |
| Tapioca Starch | 0 |
| Wheat Flour | 16.8 |
| Soybean Oil | 7.2 |

The formulation was prepared by hydrating the powdered egg whites for 30 minutes and then combining with the remaining ingredients. The formulation was then deposited on a griddle top that was heated to 200° F. for one minute until the formulation was fully opaque. Thickness was approximately 0.20 inches. The flexible film was removed from the heated surface to stop further coagulation. The flexible film was sliced into strips with approximate dimensions of 1.3 inches by 0.6 inches. The product was then fried in baked in 300° F. rice bran oil for 45 seconds. It was then baked in a convection oven at 300° F. for 35 minutes. In another variation of this recipe, the baking was done at 400° F. for 21 minutes. The resulting products were crisp and crunchy, did not contain a strong egg taste, and were not excessively oily.

The present invention has been described above with reference to preferred features and embodiments. Those skilled in the art will recognize, however, that changes and modifications may be made in these preferred embodiments without departing from the scope of the present invention.

What is claimed is:

1. An egg-based product comprising:
a solid and porous network of proteins,
wherein the egg-based product has a crispy texture,
wherein the egg-based product is low in carbohydrates, and
wherein the egg-based product has a uniform texture.

2. The egg-based product of claim 1, wherein the egg-based product has a shelf life of at least four months.

3. The egg-based product of claim 2, wherein the egg-based product has a moisture percentage between 0.25% and 10%.

4. The egg-based product of claim 3, wherein the egg-based product has a water activity of between 0.1 and 0.5.

5. The egg-based product of claim 4, wherein the egg-based product has at least 12 grams of protein in a one ounce serving.

6. The egg-based product of claim 4, further comprising:
protein from egg white;
and at least one other source of protein.

7. A method for making an egg-based product comprising:
forming a liquid formulation;
depositing the liquid formulation on a defined area to have a specific wet thickness;
heating the formulation to a desired temperature for a desired length of time to form a flexible film; and
processing of pieces of the flexible film in oil to form a crispy texture.

8. The method of claim 7, further comprising:
baking the product to form a crispy texture; and
drying the product to reduce oil and improve the textural properties.

9. The method of claim 7, wherein heating the formulation to a desired temperature for the desired length of time to form the flexible film results in gelling of egg protein.

10. The method of claim 7, wherein the flexible film comprises egg white protein that is partially unfolded and coagulated.

11. A liquid formulation used to make an egg-based product comprising:
egg whites;
a hydrocolloid;
starch, and
a flour, wherein the egg-based product has a crispy texture, is low in carbohydrates, and has a uniform texture.
